(19) United States
(12) Patent Application Publication
(10) Pub. No.: US 2014/0272143 A1
(43) Pub. Date: Sep. 18, 2014

(54) METHOD FOR FLAME RETARDING COMPOSITION

(71) Applicants: Aziz Khadbai, Plano, TX (US); Joseph Roberts Sparling, Mckinney, TX (US); James Burton Anderson, Mckinney, TX (US); Ian Douglas Buchanan, Mckinney, TX (US)

(72) Inventors: Aziz Khadbai, Plano, TX (US); Joseph Roberts Sparling, Mckinney, TX (US); James Burton Anderson, Mckinney, TX (US); Ian Douglas Buchanan, Mckinney, TX (US)

(21) Appl. No.: 13/826,078

(22) Filed: Mar. 14, 2013

(51) Int. Cl. C09K 21/04

(52) U.S. Cl. CPC C09K 21/04
USPC 427/299

(57) ABSTRACT

The present invention teaches a flame retardation composition. The composition comprises: Ammonium Polyphosphate, Sodium Borate, Boric Acid, 3% Hydrogen Peroxide Solution used as Biocide, and Distilled Water. A homogeneous flame retarding composition solution is processed by mixing the referenced composition compounds in distilled water. The flame retarding composition solution is coated on to be protected substrate surfaces against flame retardation. The materials coated with flame retarding composition solution fully satisfy flammability test under the Federal Aviation Regulation (FAR) 25.853(a) vertical burn test, and Federal Aviation Regulation (FAR) 25.853(d) heat release test. The utility of the present invention extends to numerous commercial and non-commercial applications.

### CROSS-REFERENCE TO RELATED APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the present invention generally relate to fire or flame retardation. More particularly, the present invention relates to method for flame retarding composition. The composition, without limitations, is effective for flame retardation for a plurality of combustible materials including, but not limited to, honeycomb non-metallic structural materials, a variety of plastics, synthetic wood, composite materials, and textiles from synthetic or non-synthetic fibers.

### BACKGROUND OF THE INVENTION

A number of structural or non-structural applications (commercial or non-commercial) may demand the use of combustible materials, including, but not limited to, honeycomb structural non-metallic materials, plastics, synthetic wood, and composite materials for various purposes. For example, weight to strength ratio, other material characteristics, or cost. Fire safety regulations require that combustible materials used in non-commercial or commercial applications be treated with flame retarding compositions. In efforts to comply with these regulations, manufacturers may apply flame retarding compositions to their goods. Many flame retarding compositions are known to be toxic to humans and environment. For example, fire retarding compositions including halogenated, particularly those with the halogens chlorine and bromine. Bromine flame retardants (BFRs) and Chlorinated flame retardants (CFRs) are known to cause rapid accumulation inside the human body with critical adverse effects, such as immune system suppression, cancer, endocrine disruption, neurobehavioral and developmental effects. The BFRs are widely used in consumer products, especially in plastics for electronics, foams, and textiles. It is also suspected that CFRs used in textiles, paints and coatings, plastics, and insulation foams may cause harm to humans and environment. It is to be pointed out that non-halogenated flame retardants are needed to reduce or eliminate the use of BFRs and CFRs. Accordingly, there is a need for flame retardant compositions that are not harmful to human beings, or environment.

The present invention is unique as there is no finding in the prior art that teaches or suggests the method for flame retarding composition as it is depicted in the present invention. The present invention uniquely fulfills the aforementioned need effectively and efficiently. The utility of the present invention extends to numerous commercial and non-commercial applications.

### SUMMARY OF THE INVENTION

To achieve the forgoing and other objectives and in accordance with the purpose of the present invention, method for flame retarding composition is presented. It is to be understood that the present invention is not limited to a particular methodology, system, technique, use, and application, described herein, as these may vary. It is also to be understood that the terminology used herein is for the purpose of describing particular embodiments only, and is not intended to limit the scope of the present invention.

In one embodiment of the present invention, a method for an exemplary sequence of the mode of action for flame retarding composition is provided. The composition comprises: Ammonium Polyphosphate, Sodium Borate, Boric Acid, 3% Hydrogen Peroxide Solution used as Biocide, and Distilled Water.

In another embodiment of the present invention, the method for an exemplary sequence of the mode of action for flame retarding composition comprises: mixing about 10% to about 20% by weight of Ammonium Polyphosphate, about 4% to about 5% by weight of Sodium Borate, about 4% to about 5% by weight of % by weight of Boric Acid, about 0.8% to about 1.0% by weight of 3% Hydrogen Peroxide Solution, and about 69% to about 81.2% by weight of distilled water. The distilled water temperature is maintained to about 90 degree C. for effectively dissolving the chemical compounds in distilled water.

In another embodiment of the present invention, the method for an exemplary sequence of the mode of action for the flame retarding composition solution fully satisfies the Federal Aviation Regulation (FAR) 25.853(a) vertical burn test, and Federal Aviation Regulation (FAR) 25.853(d) heat release test on coupons made from a variety of materials.

In another embodiment of the present invention, a method for an exemplary sequence of the mode of action for preparing the substrate exterior or interior surfaces for the flame retardation composition treatment. The exterior surfaces of substrate are prepared by generating or enlarging micro-voids or micro-cavities by mechanical or chemical processes.

In another embodiment of the present invention, a method for an exemplary sequence of the mode of action, the composition for flame retardation is applied to substrate surfaces by coating, painting, dipping, or spraying means.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustration of exemplary schematic depicting the process for preparing the flame retarding composition solution;

FIG. 2 is an illustration of exemplary schematic depicting the process for preparing test coupons for the flammability testing;

FIG. 3 is an illustration of exemplary schematic depicting the process for treating the substrate surfaces with flame retarding composition solution.

### DETAILED DESCRIPTION OF THE EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it must be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, the modifications and variations of the present invention are too numerous to be listed within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary person skilled in the art regarding this invention. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention is described in detail with reference to embodiments thereof as illustrated in the accompanying drawings.

From the present disclosure, other variations and modifications will be apparent to persons skilled in the art. Such variations and modifications may involve equivalents and other features which are already known in the art, and which may be used instead of or in addition to features already described herein.

Although Claims have been devised in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features described in the context of separate embodiments may also be provided in combination in a single embodiment. Conversely, various features which are, for brevity, described in the context of a single embodiment, may also be provided separately or in any suitable sub-combination. The Applicants hereby give notice that new Claims may be devised to such features or any combination of such features during the prosecution of the present Application or of any further Application derived therefrom.

References to “one embodiment,” “an embodiment,” “example embodiment,” “various embodiments,” etc., may indicate that the embodiment(s) of the present invention may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As it is well known to those skilled in the art that many careful considerations and compromises typically must be made when designing for the optimal manufacture of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, improved or optimized by those skilled in the art, using their average skills and known techniques, to achieve the desired implementation that addresses the needs of the particular application.

It is to be understood that any exact measurements or dimensions, or particular construction materials indicated herein are solely provided as examples of suitable configurations and are not intended to be limiting in any manner. Depending on the need(s) of the particular application, those skilled in the art will readily recognize, in light of the following teachings, a multiplicity of suitable alternative implementation details.

It is, specifically, emphasized that any teaching or combination of teachings, any novel feature, or any novel combination of features including the novel processing mechanism, or any combination of novel processing mechanisms for the flame retardant solution and its method of preparation and application, in accordance with an embodiment of the present invention, is clearly distinguished form the prior art, because no prior art is found either alone or in combination that teaches all of the features of the present invention.

To achieve the forgoing and other objectives and in accordance with the purpose of the present invention, the flame retarding composition solution and its method of application is presented. It is to be understood that the present invention is not limited to the particular methodology, system, techniques, uses, and applications, described herein, as these may vary. It is to be understood that the terminology used herein is used for the purpose of describing particular embodiments only, and is not intended to limit the scope of the present invention.

The present invention is illustrated by way of example, and not by way of limitation, in the figures of the accompanying drawings and in which like reference numerals refer to similar elements and in which:

FIG. 1 is an illustration of exemplary schematic depicting the process for preparing the flame retarding composition solution in accordance with an embodiment of the present invention. The schematic 100 illustrates the process for the flame retarding composition solution. The schematic 100 depicts stifling tank 102. The composition compounds 104 and distilled water 106 is added into stifling tank 102. The composition compounds 104 comprise: about 10% to about 20% by weight of Ammonium Polyphosphate, about 4% to about 5% by weight of Sodium Borate, about 4% to about 5% by weight of % by weight of Boric Acid, about 0.8% to about 1.0% by weight of 3% Hydrogen Peroxide Solution, and about 69% to about 81.2% by weight of distilled water 106. The distilled water 106 temperature is maintained to about 90 degree C. for effectively mixing the composition compounds 104 into distilled water 106 to form flame or fire retarding composition solution 108. The composition compounds 104 and distilled water 106 are stirred sufficiently enough in stirring tank 102 to form homogeneous flame or fire retardant composition solution 108. The stirring means in stirring tank 102 may comprise, but not limited to, mechanical, ultrasound vibrations, or magnetic stirring to form flame or fire retardant composition solution 108.

FIG. 2 is an illustration of exemplary schematic 200 depicting the process for preparing test coupons 202 for flammability testing under the selected standards. The test coupons 202 are prepared by using mechanical or chemical treatment means 204. The mechanical or chemical means 204 may include, but not limited to, sanding or chemical etching of test coupons 202. The objective of mechanical or chemical treatment is to generate new, or enlarge existing micro-voids 206 on test coupons 202 surfaces. It is to be pointed out that mechanical or chemical treatment means 204 are used for exterior surface preparation of test coupons 202. The micro-voids 206 are further opened to obtain enlarged micro-voids 208 by appropriate heating means 210. The appropriate heating means 210 may include, but not limited to, convection or conduction processes. The opened or enlarged micro-voids 208 surfaces are subjected to dry to touch process 212. Subsequent to dry to touch process 212, the coupon or substrate surfaces are coated with the fire or flame retardant solution 214. The coupons or substrate surfaces coated with the flame retardant solution 214 are subjected to the curing process 216. The curing process 216 is used to dry off the moisture associated with the fire or flame retardant solution 214. The cured coupons or surfaces are subjected to a cleaning process 218 using alcohol or distilled water 220 or combination of both. The treated test coupons 222 are then subjected to the flammability test 224. If the test coupons 222 pass the flammability test 226, per specific flammability test standard, the test is concluded as successful. Otherwise, the coupons flammability test 224 is repeated using fresh set of coupons treated with additional number of flame retardant solution coatings.

FIG. 3 is an illustration of exemplary schematic 300 depicting the process for treating materials or substrate surfaces 302 with the flame retardant solution 320. Mechanical or chemical means 304 may be needed to prepare the materials or substrate surfaces 302. Prior to the treatment of flame retardant solution 320, the materials or substrate surfaces 302 are subjected to a degreasing process 306, and cleaning process 308. Both, non-treated surfaces, or surfaces treated with mechanical or chemical means 304 are heat treated by heating means 314 to further open or enlarge micro-voids 312 and subsequently, the treated surfaces are cleaned with alcohol or distilled water 316. The cleaned surfaces are subjected to dry-to-touch process to obtain dry-to-touch surfaces 318. The dried-to-touch surfaces 318 are then treated with pre-determined number of coating(s) of flame retardant solution 320. The flame retardant solution treated surfaces 320 are then subjected to a curing process to obtain cured surfaces 322. Subsequently, the cured surfaces 322 are subjected to the cleaning process 324 with alcohol or distilled water 326 for the finished treated product 328.

It is to be pointed out that an extensive series of test results yield that coupons or product treated with flame retardant solution successfully pass the flammability test under the Federal Aviation Regulation (FAR) 25.853(a) vertical burn, and Federal Aviation Regulation (FAR) 25.853(d) heat release tests.

We claim:

1. A method of preparing a flame retarding composition solution comprising:
selecting at least one composition compound from Ammonium Polyphosphate, Sodium Borate, Boric Acid, 3% Hydrogen Peroxide Solution used as Biocide, and Distilled Water;
mixing said at least one composition compound in distilled water heated to about 90 degree C. to form said flame retarding composition solution;
preparing substrate surfaces for said flame retarding composition solution treatment; and
treating said substrate surfaces with said flame retarding composition solution.

2. The method of claim 1, wherein said flame retarding composition solution comprises: mixing about 10% to about 20% by weight of said Ammonium Polyphosphate, about 4% to about 5% by weight of said Sodium Borate, about 4% to about 5% by weight of % by weight of said Boric Acid, about 0.8% to about 1.0% by weight of said 3% Hydrogen Peroxide Solution, and about 69% to about 81.2% by weight of said distilled water, and wherein said distilled water temperature is maintained to about 90 degree C. to facilitate said mixing of said at least one composition compound in said distilled water.

3. The method of claim 1, wherein prepared said substrate surfaces are treated with said flame retarding composition solution by coating, dipping, or spraying process, and wherein said substrate surfaces represent materials including honeycomb non-metallic structural materials, a variety of plastics, synthetic wood, and composites.

4. The method of claim 1, wherein said flame retarding composition solution utility extends to including fabric materials, wherein said fabric materials are treated with said flame retarding solution by coating, dipping, or spraying process, and wherein said fabric materials are made from synthetic or non-synthetic fibers.
